(19) United States
(12) Patent Application Publication
(10) Pub. No.: US 2025/0243312 A1
(43) Pub. Date: Jul. 31, 2025

(54) LOW-DENSITY POLYURETHANE FOAM

(71) Applicant: SHELL USA, INC., Houston, TX (US)

(72) Inventors: Pranaya Man Singh PRADHAN, Singapore (SG); Prem Kumar DHANAPAL, Bangalore North (IN)

(21) Appl. No.: 18/853,875

(22) PCT Filed: Apr. 18, 2023
(86) PCT No.: PCT/EP2023/060039

§ 371 Date: Oct. 3, 2024

(30) Foreign Application Priority Data
Apr. 25, 2022 (EP) 22169694.1

(51) Int. Cl. C08G 18/08; C08G 18/12; C08G 18/18; C08G 18/22; C08G 18/32; C08G 18/48; C08G 101/00; C08J 9/12

(52) U.S. Cl. CPC C08G 18/14; C08G 18/12; C08G 18/18; C08G 18/222; C08G 18/3206; C08G 18/4845; C08J 9/125; C08G 2101/00; C08G 2110/005; C08J 2203/10; C08J 2375/08

(57) ABSTRACT

The invention relates to a process for preparing a polyurethane foam having a density lower than 30 kg/m3 which process comprises reacting, in the presence of a blowing agent: a) a polyisocyanate component; b) a polyether polyol component having a molecular weight of at least 1.000 g/mol and a functionality which is higher than 1.5 and lower than 2.5; and c) a chain extender component having a molecular weight of at most 500 g/mol and a functionality which is higher than 1.5 and lower than 2.5.

### FIELD OF THE INVENTION

The present invention relates to a process for preparing a polyurethane foam, to a polyurethane foam obtainable by said process, and to a shaped article comprising said polyurethane foam.

### BACKGROUND OF THE INVENTION

Polyurethane foams, in specific flexible polyurethane foams, have found extensive use in a multitude of industrial and consumer applications. For some applications, it may be required that flexible polyurethane foams have a relatively low density, especially lower than 30 kg/m³. Further, advantageously, the costs for making a low-density foam are relatively low. Furthermore, low-density foam has a relatively low weight, which implies that it can be handled easier and that transportation requires less energy. Still further, low-density polyurethane foam is more sustainable, as compared to high-density polyurethane foam, in that a lower amount of polyether polyols and polyisocyanates is required to make the same volume of foam.

Polyurethane foams may be made by reacting a polyether polyol and a polyisocyanate in the presence of a blowing agent. It is known to lower the foam density by increasing the amount of blowing agent, which may for example be water and/or a halogenated hydrocarbon, such as methylene chloride (dichloromethane), and/or liquid carbon dioxide. Generally, in the industrial production of low-density polyurethane foams, especially slabstock foams, polyether polyols having a relatively high functionality, especially higher than 2.5, are used. It would be advantageous to make low-density polyurethane foam using a polyether polyol having a relatively low functionality, especially lower than 2.5, because using such low-functionality polyol may have one or more of the following advantages.

First of all, low-functionality polyols intrinsically have a lower viscosity at the same equivalent weight, which makes them easier to handle.

Additionally, being able to use a low-functionality polyol in making polyurethane foam is especially relevant for polymer polyols, which are dispersions of a solid polymer in a liquid polyol. By decreasing the polyol viscosity, a relatively higher polymer amount may be included, while maintaining the same overall viscosity for the polymer polyol. Further, increasing such (solid) polymer content is advantageous because this may impart hardness to the foam.

This is beneficial in that the relative amount of polyisocyanate, which may also increase such hardness, with respect to the amount of polymer polyol may be decreased while maintaining the same foam hardness.

Further, by using low-functionality polyether polyols a relatively high elongation at break may be achieved for the resulting polyurethane foam. This concerns the maximum elongation that a foam can achieve before it breaks. A high elongation at break is for example relevant for face masks, in specific for polyurethane-based elastic cords of face masks which cords are positioned behind the ears.

Still further, by using a low-functionality polyether polyol, generally a softer foam may be obtained than by using a polyether polyol having a higher functionality. The use of a halogenated hydrocarbon, such as methylene chloride, or liquid carbon dioxide as a blowing agent may also generally result in a relatively soft foam. However, there are health and safety concerns associated with the use of halogenated hydrocarbons. Furthermore, making foam using liquid carbon dioxide is complex as it is technically demanding, and hence relatively expensive. Hence, it would be desired to be able to prepare a low-density polyurethane foam from a low-functionality polyether polyol which foam is sufficiently soft, wherein no or less halogenated hydrocarbons and/or liquid carbon dioxide need to be used as a blowing agent.

However, a polyurethane foam produced from a low-functionality polyol having or resulting in the above-described advantages, should still meet other desired foam properties, such as foam stability during the production of foam. It is known that the more blowing agent is used and hence the lower the foam density becomes, the less stable the foam becomes. Thus, for low-density polyurethane foam, it is especially important to ensure that foam stability is not impaired. In specific, foam instability may be shown by a so-called “sink back” of the foam and/or by a relatively low foam height (low foam rise) and/or even by a split or a collapse of the foam. Said sink back refers to a phenomenon wherein after reaching a certain height the foam height is reduced. A disadvantage of such sink back is that the final foam density is not distributed evenly and/or that the final foam height is relatively low.

Furthermore, foam stability after the production of foam is also important, that is to say the foam stability after the foam has cooled down to ambient temperature. It is desired that the cooled foam retains its original shape and does not shrink in one or more dimensions.

The stability of a polyurethane foam may be determined by the extent to which cross-linking may occur in the foam production process. Such cross-linking in turn is primarily determined by the functionality of the reactants (polyether polyols and polyisocyanates). The higher the functionality of these reactants, the more cross-linking may occur. Because high-density polyurethane foam as such is already relatively stable because of its increased density, as compared to low-density polyurethane foam, such high-density polyurethane foam may generally be prepared from either high-functionality reactants or low-functionality reactants. However, this is not the case with low-density polyurethane foam, which is why, as mentioned above, in the industrial production of low-density polyurethane foams, polyether polyols having a relatively high functionality are generally used.

Furthermore, it is known that polyurethane foam stability may decrease when foam volume increases. This is especially relevant in the industrial production of low-density polyurethane foams, especially slabstock foams, wherein the foam volume may be relatively large, for example at least 1 m³ (i.e. at least 1,000 liters).

It is an object of the invention to provide a process for preparing a low-density polyurethane foam, which is prepared by reacting, in the presence of a blowing agent, a polyisocyanate and a polyether polyol, said polyol having a relatively low functionality, which foam has one or more of the above-described desired properties and advantages, including high stability, high foam elongation at break and increased softness.

### SUMMARY OF THE INVENTION

Surprisingly it was found that the above-mentioned object may be achieved by a process for preparing a polyurethane foam having a density lower than 30 kg/m³ and comprising reacting a polyisocyanate and a polyether polyol in the presence of a blowing agent, in which process a polyether polyol having a relatively low functionality, namely higher than 1.5 and lower than 2.5, is used in combination with a chain extender which has a lower molecular weight but which also has such low functionality.

Accordingly, the present invention relates to a process for preparing a polyurethane foam having a density lower than 30 kg/m³ which process comprises reacting, in the presence of a blowing agent:
a) a polyisocyanate component;
b) a polyether polyol component having a molecular weight of at least 1,000 g/mol and a functionality which is higher than 1.5 and lower than 2.5; and
c) a chain extender component having a molecular weight of at most 500 g/mol and a functionality which is higher than 1.5 and lower than 2.5.

Further, the present invention relates to a polyurethane foam obtainable by the above-mentioned process for preparing a polyurethane foam, and to a shaped article comprising a polyurethane foam obtained or obtainable by said process.

It has been found that for low-density polyurethane foams having a density lower than 30 kg/m³, prepared by reacting a polyisocyanate and a polyether polyol in the presence of a blowing agent, wherein the polyether polyol has a relatively low functionality, namely higher than 1.5 and lower than 2.5, also a chain extender, which has a lower molecular weight, should be used in combination with that polyether polyol, which chain extender likewise has a relatively low functionality, namely higher than 1.5 and lower than 2.5, in order to produce a stable foam.

WO2019122122 concerns a process for preparing a polyurethane foam having a relatively high density, namely between 30 and 150 g/l (between 30 and 150 kg/m³), wherein an isocyanate component having a functionality between 1.9 and 2.2 is reacted with a polyol component having a functionality between 1.7 and 2.2, in the presence of a blowing agent and a catalyst. According to said WO2019122122, the polyol component may be a polyester polyol or a polyether polyol having an average molecular weight between 500 and 12,000 g/mol. Further, according to said WO2019122122, said polyol component may additionally comprise a chain extender, which may have a molecular weight of 50 to 499 g/mol and which may have 2 isocyanate-reactive functional groups, such as butane-1,4-diol.

The object of above-mentioned WO2019122122 is to find suitable flexible polyurethane foams and hybrid materials which, after utilization or use or at the end of lifetime, can be processed thermoplastically (extrusion, injection molding) in order to obtain a starting material/pelletized material of value for applications, for example for injection-molded or extruded products. That is to say, said WO2019122122 is concerned with physical (non-chemical) processing of used polyurethane foam followed by re-use of the resulting recycled processed foam material.

### DETAILED DESCRIPTION OF THE INVENTION

While the processes and compositions of the present invention may be described in terms of “comprising”, “containing” or “including” one or more various described steps and components, respectively, they can also “consist essentially of” or “consist of” said one or more various described steps and components, respectively.

In the context of the present invention, in a case where a composition comprises two or more components, these components are to be selected in an overall amount not to exceed 100 wt. %.

Where upper and lower limits are quoted for a property then a range of values defined by a combination of any of the upper limits with any of the lower limits is also implied.

The term “molecular weight” (or “MW”) is used herein to refer to number average molecular weight, unless otherwise specified or context requires otherwise. The number average molecular weight of a polyol can be measured by gel permeation chromatography (GPC) or vapor pressure osmometry (VPO).

The term “hydroxyl (OH) value” or “hydroxyl (OH) number” is used herein to refer to the milligrams of potassium hydroxide equivalent to the hydroxyl content in one gram of polyol determined by wet method titration. Hence, said OH value or number is expressed in mg KOH/g.

The term “equivalent weight” (or “EW”) is used herein to refer to the weight of polyol per reactive site. The equivalent weight is 56,100 divided by the hydroxyl value of the polyol.

The term “functionality” or “hydroxyl (OH) functionality” of a polyol refers to the number of hydroxyl groups per molecule of polyol. The nominal functionality (or “Fn”) of a polyol is the same as that of its starter compound (initiator). Unless indicated otherwise, functionality refers to the actual average functionality which may be lower than the nominal functionality and is determined by the number average molecular weight of the polyol divided by the equivalent weight of the polyol.

The term “functionality” of a polyisocyanate refers to the average number of isocyanate groups per molecule of polyisocyanate.

The term “functionality” of a chain extender for chain extender component c) refers to the average number of functional groups containing active hydrogen atoms per molecule of chain extender. Examples of such active hydrogen atoms are hydrogen atoms directly attached to an oxygen or nitrogen atom (such as in —OH, —NH₂ and —NHR groups).

The term “primary hydroxyl content” (or “PHC”) is used herein to refer to the relative proportion (in %) of primary hydroxyl groups in a polyether polyol based on total number of hydroxyl groups including primary and secondary hydroxyl groups.

The terms “ethylene oxide content” and “propylene oxide content”, respectively, in relation to a polyether polyol refer to those parts of the polyol which are derived from ethylene oxide and propylene oxide, respectively. Said contents may also be referred to as oxyethylene content and oxypropylene content, respectively. Further, said contents are based herein on total alkylene oxide weight.

In the present invention, polyether polyol component b) has a molecular weight of at least 1,000 g/mol and a functionality which is higher than 1.5 and lower than 2.5. Thus, the molecular weight of polyether polyol component b) is higher than that of chain extender component c), whereas the functionalities of both said components are higher than 1.5 and lower than 2.5.

In the present invention, polyether polyol component b) may have a molecular weight of at most 12,000 g/mol, suitably of from 1,000 to 10,000 g/mol, more suitably of from 1,000 to 7,000 g/mol, most suitably of from 1,500 to 5,000 g/mol. Said molecular weight is at least 1,000 g/mol, preferably at least 1,250 g/mol, more preferably at least 1,500 g/mol, most preferably at least 1,750 g/mol. Further, said molecular weight is preferably at most 12, 000 g/mol, preferably at most 10,000 g/mol, more preferably at most 8,000 g/mol, more preferably at most 7,000 g/mol, more preferably at most 5,000 g/mol, more preferably at most 4,000 g/mol, more preferably at most 3,000 g/mol, most preferably at most 2,500 g/mol.

Further, in the present invention, polyether polyol component b) preferably has a functionality of from 1.7 to 2.2, more preferably of from 1.9 to 2.2, most preferably of from 1.9 to 2.1. Said functionality is higher than 1.5 and is preferably at least 1.6, more preferably at least 1.7, more preferably at least 1.8, most preferably at least 1.9. Further, said functionality is lower than 2.5 and is preferably at most 2.4, more preferably at most 2.3, more preferably at most 2.2, more preferably at most 2.1, most preferably at most 2.0. Said functionality may be 2.0.

Polyether polyol component b) may comprise one or more polyether polyols. In case polyether polyol component b) comprises two or more polyether polyols, the properties described in this specification for polyether polyol component b), including functionality, apply to the mixture of the two or more polyether polyols, with the proviso that the molecular weight of each of said polyether polyols should be at least 1,000 g/mol as described above. Further, it is preferred that the functionality of each of said polyether polyols is higher than 1.5 and lower than 2.5 as described above. The basis for calculating an average property for said mixture is a molar basis. If polyether polyol component b) comprises one or more polyether polyols having a functionality of 2.5 or higher, or higher than 2.2, the proportion of said one or more polyether polyols having a higher functionality is preferably not more than 10 wt. %, more preferably not more than 5 wt., based on the overall mixture. If 2 or more polyols are used, they may be provided as a polyol mixture, or the polyols may be provided separately to form a polyol mixture in situ.

In the present invention, polyether polyol component b) comprises one or more polyether polyols which are prepared by ring-opening polymerization of an alkylene oxide in the presence of an initiator having a plurality of active hydrogen atoms and a catalyst. Said catalyst may be a basic catalyst, such as potassium hydroxide (KOH), or a composite metal cyanide complex catalyst, which latter catalyst is frequently also referred to as double metal cyanide (DMC) catalyst. Preferably, said catalyst is a DMC catalyst.

In the present invention, the one or more polyether polyols in polyether polyol component b) comprise polyether polyols containing ether linkages (or ether units). It is preferred that said polyether polyols do not contain ester linkages (or ester units). Further, said polyether polyols may consist of ether linkages. Still further, said polyether polyols may also contain carbonate linkages (or carbonate units). Further, it is preferred that said polyether polyols contain no atoms other than carbon, hydrogen and oxygen.

Preferably, in the present invention, said one or more polyether polyols comprise polyether chains containing propylene and/or butylene oxide content, more preferably propylene oxide (PO) content, and optionally ethylene oxide (EO) content.

Preferably, polyether polyol component b) comprises polyether chains containing of from 0 wt. % to 25 wt. % of EO content. The EO content may be 100 wt. % or at most 90 wt. % or at most 80 wt. % or at most 70 wt. % or at most 60 wt. % or at most 50 wt. % or at most 40 wt. % or at most 30 wt. % or at most 25 wt. % or at most 20 wt. % or at most 15 wt. % or at most 12 wt. %. Further, the EO content may be 0 wt. % or at least 3 wt. % or at least 5 wt. % or at least 10 wt. % or at least 12 wt. % or at least 15 wt. % or at least 20 wt. % or at least 30 wt. % or at least 40 wt. % or at least 50 wt. % or at least 60 wt. % or at least 70 wt. % or at least 80 wt. % or at least 90 wt. %.

Preferably, the remainder of the alkylene oxide content in the polyether chains of polyether polyol component b) is derived from propylene and/or butylene oxide. More preferably, the remainder of the alkylene oxide content in the polyether chains of polyether polyol component b) is derived from propylene oxide. Therefore, the polyether chains of polyether polyol component b) preferably comprise at least 75 wt. %, more preferably at least 80 wt. %, most preferably at least 85 wt. % of propylene oxide (PO) content. Further, the polyether chains of polyether polyol component b) may comprise 100 wt. % of PO content and preferably comprise at most 97 wt. %, more preferably at most 95 wt. %, most preferably at most 94 wt. % of PO content.

In the present invention, the polyether chains of polyether polyol component b) may comprise no ethylene oxide content but may comprise only propylene and/or butylene oxide content, suitably only propylene oxide content.

Polyether polyol component b) may comprise primary hydroxyl groups. The percentage of primary hydroxyl groups (also referred to as “primary hydroxyl content (PHC)”) may be in the range of from 1 to 100, suitably of from 1 to 75, more suitably of from 1 to 50, more suitably of from 1 to 30, more suitably of from 1 to 20, most suitably of from 1 to 15.

Further, polyether polyol component b) preferably has a hydroxyl value of at least 15, more preferably at least 20, more preferably at least 25, more preferably at least 30, more preferably at least 35, most preferably at least 45. Further, polyether polyol component b) preferably has a hydroxyl value of at most 100, preferably at most 90, more preferably at most 80, more preferably at most 75, most preferably at most 60.

In preparing the one or more polyether polyols having above-described relatively low functionality, which one or more polyols are part of polyether polyol component b), said initiator having a plurality of active hydrogen atoms should have a correspondingly low functionality. One or more initiators may be used. Preferably, the functionality of said one or more initiators is higher than 1.5 and lower than 3.0, more preferably of from 1.7 to 2.5, more preferably of from 1.9 to 2.5, more preferably of from 1.9 to 2.2, most preferably of from 1.9 to 2.0. Said functionality may be 2.0. Such initiators may be one or more of water and a glycol. A glycol is an alcohol containing two hydroxyl (OH) groups wherein each OH group is attached to a different carbon atom. Said different carbon atoms may or may not be adjacent, and are preferably adjacent. Such initiators may suitably comprise one or more of water, monoethylene glycol, monopropylene glycol, butanediol, diethylene glycol and dipropylene glycol, more suitably one or more of water, monoethylene glycol and monopropylene glycol, most suitably one or more of monoethylene glycol and monopropylene glycol. Said butanediol may be any one of butane-1,4-diol, butane-1,2-diol and butane-2,3-diol, preferably butane-1,4-diol. In case a mixture of initiators is used, the mole average functionality for the mixture should be within one or more of said ranges.

Thus, in preparing the one or more polyether polyols from polyether polyol component b), it is preferred to use a composite metal cyanide complex catalyst. Composite metal cyanide complex catalysts are frequently also referred to as double metal cyanide (DMC) catalysts. A composite metal cyanide complex catalyst is typically represented by the following formula (1):

M¹ₐ[M²_{b}(CN)_{c}]_{d}·e(M¹_{f}X_{g})·h(H₂0)·i(R) (1)

wherein each of M¹ and M² is a metal, X is a halogen atom, R is an organic ligand, and each of a, b, c, d, e, f, g, h and i is a number which is variable depending upon the atomic balances of the metals, the number of organic ligands to be coordinated, etc.

In the above formula (1), M¹ is preferably a metal selected from Zn(II) or Fe(II). In the above formula, M² is preferably a metal selected from Co(III) or Fe(III). However, other metals and oxidation states may also be used, as is known in the art.

In the above formula (1), R is an organic ligand and is preferably at least one compound selected from the group consisting of an alcohol, an ether, a ketone, an ester, an amine and an amide. As such an organic ligand, a water-soluble one may be used. Specifically, one or more compounds selected from tert-butyl alcohol, n-butyl alcohol, iso-butyl alcohol, tert-pentyl alcohol, isopentyl alcohol, N,N-dimethyl acetamide, glyme (ethylene glycol dimethyl ether), diglyme (diethylene glycol dimethyl ether), triglyme (triethylene glycol dimethyl ether), ethylene glycol mono-tert-butylether, iso-propyl alcohol and dioxane, may be used as organic ligand(s). The dioxane may be 1,4-dioxane or 1,3-dioxane and is preferably 1,4-dioxane. Most preferably, the organic ligand or one of the organic ligands in the composite metal cyanide complex catalyst is tert-butyl alcohol. Further, as an alcohol organic ligand, a polyol, preferably a polyether polyol may be used. More preferably, a poly (propylene glycol) having a number average molecular weight in the range of from 500 to 2,500 Dalton, preferably 800 to 2,200 Dalton, may be used as the organic ligand or one of the organic ligands. Most preferably, such poly (propylene glycol) is used in combination with tert-butyl alcohol as organic ligands. The composite metal cyanide complex catalyst can be produced by known production methods.

In the present invention, one or more of the polyether polyols from polyether polyol component b) may be part of a polymer polyol. That is to say, one or more polymers may be dispersed in said one or more polyether polyols. In particular, a solid polymer may be dispersed in said polyol(s), thereby forming a “polymer polyol”. The base polyol of such polymer polyol may have properties as described above for polyether polyol component b) in general. Thus, in general, a polymer polyol is a dispersion of a solid polymer in a liquid polyol. Such systems are well known in the art and are normally prepared by polymerising one or more ethylenically unsaturated monomers in the presence of a free radical catalyst.

Examples of such polymer polyol systems and methods for their preparation are disclosed in, for instance, EP076491A2, EP0343907A2 and EP0495551A2. Polyurea or polyurethane polymers are also known to be useful as the dispersed polymer in polymer polyols instead of the polymers based on ethylenically unsaturated monomers.

The polymer dispersed in the base polyol, may in principle be any such polymer known to be applicable for this purpose. Thus, suitable polymers include the polymers based on ethylenically unsaturated monomers and particularly polymers of vinyl aromatic hydrocarbons, like styrene, alpha-methyl styrene, methyl styrene and various other alkyl-substituted styrenes. Of these, the use of styrene is preferred. The vinyl aromatic monomer may be used alone or in combination with other ethylenically unsaturated monomers, such as acrylonitrile, methacrylonitrile, vinylidene chloride, various acrylates and conjugated dienes like 1,3-butadiene and isoprene. Preferred polymers, however, are polystyrene and styrene-acrylonitrile (SAN) copolymers. Another suitable class of polymers are the polyurea and polyurethane polymers. Particularly the condensation products of primary amines or polyhydric alcohol amines and aromatic diisocyanates are very useful in this respect. One suitable polymer is the condensation product of triethanolamine and toluene diisocyanate (TDI).

The dispersed polymer is suitably present in an amount of from 10 to 75 wt. %, more suitably 10 to 65 wt. %, more suitably 10 to 55 wt. %, more suitably 15 to 55 wt. %, more suitably 30 to 45 wt. %, based on total weight of the polyol and polymer.

In the present invention, it is preferred that no polyether polyol component other than polyether polyol component b) as described above is used. In said preferred case, chain extender component c) is still used as required in the present invention. Chain extender component c) may comprise one or more polyether polyols as described below. That is to say, in said preferred case, it is preferred that no polyether polyol component other than polyether polyol component b) as described above and no polyether polyol component other than chain extender component c) as described below is used.

In the present invention, chain extender component c) has a molecular weight of at most 500 g/mol and a functionality which is higher than 1.5 and lower than 2.5. Thus, the molecular weight of chain extender component c) is lower than that of polyether polyol component b), whereas the functionalities of both said components are higher than 1.5 and lower than 2.5.

Within the present specification, a “chain extender” means a compound which contains hydroxyl and/or amine groups, and which has a relatively low molecular weight, which in the present invention is at most 500 g/mol, and a relatively low functionality, which in the present invention is higher than 1.5 and lower than 2.5. It is preferred in the present invention that said chain extender contains no atoms other than carbon, hydrogen and oxygen. In said preferred case, the chain extender does not contain any amine group.

In the present invention, chain extender component c) may have a molecular weight of at least 50 g/mol, suitably of from 60 to 500 g/mol, more suitably of from 60 to 300 g/mol, most suitably of from 60 to 200 g/mol. Said molecular weight is preferably at least 50 g/mol, more preferably at least 60 g/mol, more preferably at least 65 g/mol, more preferably at least 70 g/mol, more preferably at least 75 g/mol, more preferably at least 80 g/mol, most preferably at least 85 g/mol. Further, said molecular weight is at most 500 g/mol, preferably at most 400 g/mol, more preferably at most 350 g/mol, more preferably at most 300 g/mol, more preferably at most 250 g/mol, more preferably at most 200 g/mol, more preferably at most 150 g/mol, more preferably at most 120 g/mol, most preferably at most 100 g/mol.

Further, in the present invention, chain extender component c) preferably has a functionality of from 1.7 to 2.2, more preferably of from 1.9 to 2.2, most preferably of from 1.9 to 2.1. Said functionality is higher than 1.5 and is preferably at least 1.6, more preferably at least 1.7, more preferably at least 1.8, most preferably at least 1.9. Further, said functionality is lower than 2.5 and is preferably at most 2.4, more preferably at most 2.3, more preferably at most 2.2, more preferably at most 2.1, most preferably at most 2.0. Said functionality may be 2.0.

Chain extender component c) may comprise one or more chain extenders. In case chain extender component c) comprises two or more chain extenders, the properties described in this specification for chain extender component c), including functionality, apply to the mixture of the two or more chain extenders, with the proviso that the molecular weight of each of said chain extenders should be at most 500 g/mol as described above. Further, it is preferred that the functionality of each of said extenders is higher than 1.5 and lower than 2.5 as described above. The basis for calculating an average property for said mixture is a molar basis. If 2 or more chain extenders are used, they may be provided as a chain extender mixture, or the chain extenders may be provided separately to form a chain extender mixture in situ.

In the present invention, chain extender component c) may comprise one or more chain extenders selected from the group consisting of aliphatic, araliphatic, aromatic and cycloaliphatic compounds. Said chain extenders comprise isocyanate-reactive functional groups, including hydroxyl and/or amine groups. Preferred chain extenders are diamines and/or alkanediols, more preferably alkanediols having 2 to 10 carbon atoms, preferably 3 to 8 carbon atoms. Further, it is preferred that said alkanediols have solely primary hydroxyl groups.

Chain extender component c) comprises preferably at least one chain extender selected from the group consisting of 1,2-ethylene glycol, propane-1,3-diol, decane-1,10-diol, 1,2-, 1,3-, 1,4-dihydroxycyclohexane, diethylene glycol, dipropylene glycol, tripropylene glycol, butane-1,4-diol, hexane-1,6-diol and bis(2-hydroxyethyl)hydroquinone, and low molecular weight polyalkylene oxides that contain hydroxyl groups and are based on ethylene oxide and/or propylene oxide and the aforementioned diols as starter molecules. Further, chain extender component c) may comprise at least one aromatic amine selected from the group consisting of diethyltoluenediamine, 3,3″-dichloro-4,4″-diaminodiphenylmethane, 3,5-diamino-4-chloroisobutyl benzoate, 4-methyl-2,6-bis(methylthio)-1,3-diaminobenzene, trimethylene glycol di-p-aminobenzoate and 2,4-diamino-3,5-di(methylthio)toluene. Such aromatic aminic chain extenders can be sourced from various manufacturers and are known to the person skilled in the art usually also by various abbreviations, for example MOCA, MBOCA, MCDEA, DETA. It is particularly preferred that chain extender component c) comprises at least one chain extender selected from the group consisting of 1,2-ethylene glycol, propane-1,3-diol, butane-1,4-diol, hexane-1,6-diol, dipropylene glycol and tripropylene glycol, more preferably from the group consisting of butane-1,4-diol, dipropylene glycol and tripropylene glycol. Most preferably, chain extender component c) comprises butane-1,4-diol.

In the present invention, it is preferred that no chain extender component other than chain extender component c) as described above is used. In said preferred case, polyether polyol component b) is still used as required in the present invention.

In the present invention, the weight ratio of polyether polyol component b) to chain extender component c) may be of from 5:1 to 500:1, more suitably of from 15:1 to 250:1, most suitably of from 30:1 to 100:1. Said weight ratio may be at least 5:1 or at least 10:1 or at least 15:1 or at least 20:1 or at least 25:1 or at least 30:1 or at least 35:1 or at least 40:1 or at least 45:1 or at least 50:1 or at least 60:1 or at least 80:1 or at least 90:1. Further, said weight ratio may be at most 500:1 or at most 300:1 or at most 250:1 or at most 200:1 or at most 150:1 or at most 100:1.

Suitably, polyether polyol component b) and chain extender component c) are prepared in separate processes wherein said components are not prepared simultaneously in the same reactor vessel.

In the present process, polyether polyol component b) and chain extender component c) are reacted with polyisocyanate component a) in the presence of a blowing agent.

In the present invention, polyisocyanate component a) preferably has a functionality of from 1.7 to 2.2, more preferably of from 1.9 to 2.2, most preferably of from 1.9 to 2.1. Said functionality is preferably higher than 1.5 and is more preferably at least 1.6, more preferably at least 1.7, more preferably at least 1.8, most preferably at least 1.9. Further, said functionality is preferably lower than 2.5 and is more preferably at most 2.4, more preferably at most 2.3, more preferably at most 2.2, more preferably at most 2.1, most preferably at most 2.0. Said functionality may be 2.0.

Polyisocyanate component a) may comprise an aromatic polyisocyanate or an aliphatic polyisocyanate, preferably an aromatic polyisocyanate.

The aromatic polyisocyanate may for example comprise tolylene diisocyanate (TDI) or polymeric TDI, xylylene diisocyanate, tetramethylxylylene diisocyanate, methylene diphenyl diisocyanate (MDI) or polymeric MDI (i.e. polymethylene polyphenyl isocyanate), or a modified product thereof. Preferably, the aromatic polyisocyanate comprises tolylene diisocyanate (TDI), i.e. non-polymeric TDI. The TDI may be a mixture of 80 wt. % of 2,4-TDI and 20 wt. % of 2,6-TDI, which mixture is sold as “TDI-80”.

Further, the aliphatic polyisocyanate may for example comprise hexamethylene diisocyanate, dicyclohexylmethane diisocyanate, lysine diisocyanate or isophorone diisocyanate, or a modified product thereof.

Further, polyisocyanate component a) may comprise any mixture of two or more of the polyisocyanates mentioned above. For example, polyisocyanate component a) may comprise a mixture of TDI and MDI, in particular a mixture wherein the weight ratio of TDI:MDI varies from 10:90 to 90:10.

In the present invention, it is preferred that no polyisocyanate component other than polyisocyanate component a) as described above is used.

In the present invention, the blowing agent may comprise a chemical blowing agent and/or a physical (non-chemical) blowing agent. Within the present specification, by “chemical blowing agent” reference is made to a blowing agent that may only provide a blowing effect after it has chemically reacted with another compound. In case the blowing agent comprises a chemical blowing agent, said chemical blowing agent preferably comprises water. Water reacts with isocyanate groups of the polyisocyanate, thereby releasing carbon dioxide which causes the blowing to occur.

However, other suitable blowing agents, such as for example, acetone, gaseous or liquid carbon dioxide, halogenated hydrocarbons, aliphatic alkanes and alicyclic alkanes may be employed additionally or alternatively.

Due to the ozone depleting effect of fully chlorinated, fluorinated alkanes (CFC's) the use of this type of blowing agent is generally not preferred, although it is possible to use them within the scope of the present invention. Halogenated alkanes, wherein at least one hydrogen atom has not been substituted by a halogen atom (including the so-called HCFC's) have no or less ozone depleting effect and therefore are the preferred halogenated hydrocarbons to be used in physically blown foams. One suitable HCFC type blowing agent is 1-chloro-1,1-difluoroethane. Another suitable halogenated alkane of this type for use as a blowing agent, is methylene chloride (dichloromethane).

The above blowing agents may be used singly or in mixtures of two or more.

In the present invention, the amount of the blowing agent(s) is determined by the density of the polyurethane foam to be prepared which should be lower than 30 kg/m³. Such relatively low density can be obtained by using a relatively high amount of the blowing agent(s). A skilled person can readily determine the amount of blowing agent (physical and/or chemical blowing agent) needed to obtain a foam density lower than 30 kg/m³ or lower than any one of the other above-mentioned upper limits.

It is known that the blowing effect of different blowing agents is different. This can be expressed in terms of a so-called “blow index” with which the blowing effect can be approximated. Suitably, a blow index may be defined as follows (as exemplified for a case wherein the blowing agent comprises 2 different blowing agents): blow index [in pbw]=(amount blowing agent 1)/factor blowing agent 1+(amount blowing agent 2)/factor blowing agent 2. “pbw” stands for “parts by weight” per 100 parts of polyol which is the same as “parts per hundred parts by weight of polyol” (pphp). Further, the density of a polyurethane foam when applying such blow index, may suitably be approximated as follows: density=98/blow index. Hence, in order to obtain a density lower than 30 kg/m³, as required in the present invention, said blow index should be greater than 3.2 pbw. Suitably, in the present invention, said blow index may be of from 3.3 to 8. The factors for some blowing agents in said blow index are as follows: water=1; liquid carbon dioxide=2.5-3.0; methylene chloride=8. For example, in case a blowing agent consists of 3.6 pbw of water and 8 pbw of methylene chloride, the blow index of that mixture is 4.6 (3.6/1+8/8), which would result in a foam density of 21.3 kg/m³ (98/4.6). Said blow index and density calculated therefrom are indicative (approximated values). The actual density may deviate from such calculated value and needs to be determined experimentally (for example with below-mentioned ASTM D3574 method).

In the present invention, in case one or more additional blowing agents are used, water may be used as a blowing agent in a relatively low amount which may be at least 0.5 or at least 1 or at least 1.5 or at least 2 or at least 2.5 parts per hundred parts by weight of polyol (pphp). Preferably, in the present invention, in a case where the blowing agent comprises or consists of water, water is used in an amount of from 3 to 10 parts per hundred parts by weight of polyol (pphp), more preferably of from 3 to 8 pphp, more preferably of from 3 to 7 pphp, more preferably of from 4 to 7 pphp, most preferably of from 4 to 6 pphp. Preferably, water is used in an amount which is at least 3.1 pphp, more preferably at least 3.3 pphp, more preferably at least 3.5 pphp, more preferably at least 3.7 pphp, more preferably at least 4 pphp, more preferably at least 4.5 pphp, most preferably at least 5 pphp. Further, preferably, water is used in an amount which is at most 10 pphp, more preferably at most 9 pphp, more preferably at most 8 pphp, more preferably at most 7 pphp, most preferably at most 6 pphp.

In case of halogenated hydrocarbons, aliphatic alkanes and alicyclic alkanes, the amount of the blowing agent may be of from 1 to 50 parts per hundred parts by weight of polyol (pphp), suitably of from 1 to 30 pphp, more suitably of from 1 to 20 pphp.

In the present invention, the density of the polyurethane foam to be prepared is lower than 30 kg/m³, preferably at most 28 kg/m³, preferably at most 26 kg/m³, more preferably at most 25 kg/m³, more preferably at most 24 kg/m³, most preferably at most 23 kg/m³. Further, preferably, the density is at least 6 kg/m³, more preferably at least 10 kg/m³, more preferably at least 12 kg/m³, more preferably at least 14 kg/m³, more preferably at least 16 kg/m³, more preferably at least 18 kg/m³, more preferably at least 19 kg/m³, most preferably at least 20 kg/m³. Thus, the density of the polyurethane foam to be prepared may be of from 6 to lower than 30 kg/m³, preferably of from 12 to 28 kg/m³, more preferably of from 16 to 26 kg/m³, more preferably of from 18 to 24 kg/m³, most preferably of from 19 to 23 kg/m³. The density may be determined by measuring the weight of a 10 cm*10 cm*5 cm cube of foam, for example, according to ASTM D3574.

Further, preferably, the polyurethane foam to be prepared in the present process is a flexible polyurethane foam. Further, said flexible polyurethane foam is suitably a slabstock foam. Within the present specification, by “slabstock foam” reference is made to a foam that is made by applying a free rise (unconstrained rise) of the foam. In the present invention, the isocyanate index (or NCO index) may be at most 150, more suitably at most 140, more suitably at most 130, more suitably at most 125, most suitably at most 120. The isocyanate index is preferably higher than 90, more preferably higher than 95, more preferably higher than 100, most preferably higher than 105. Suitably, the isocyanate index is of from 95 to 140, more suitably of from 100 to 120, most suitably of from 105 to 115.

Within the present specification, “isocyanate index” is calculated as 100 times the mole ratio of-NCO groups (isocyanate groups) to NCO-reactive groups in the reaction mixture. In other words, the isocyanate index is defined as: [(actual amount of isocyanate)/(theoretical amount of isocyanate)]*100, wherein the “theoretical amount of isocyanate” equals 1 equivalent isocyanate (NCO) group per 1 equivalent isocyanate-reactive group.

Such “isocyanate-reactive groups” as referred to above include for example OH groups and any NH₂ groups from polyether polyol component b) and chain extender component c) and from any water that may be used as a blowing agent. Isocyanate groups also react with water.

Additionally, other components may also be present during the polyurethane preparation process of the present invention, such as one or more polyurethane catalysts, surfactants and/or cross-linking agents.

Polyurethane catalysts are known in the art and include many different compounds. For the purpose of the present invention, suitable catalysts include tin-, lead- or titanium-based catalysts, preferably tin-based catalysts, such as tin salts and dialkyl tin salts of carboxylic acids. Specific examples are stannous octoate, stannous oleate, dibutyltin dilaureate, dibutyltin acetate and dibutyltin diacetate. Other suitable catalysts are tertiary amines, such as, for instance, bis(2,2′-dimethylamino)ethyl ether, trimethylamine, triethylamine, triethylenediamine and dimethylethanolamine (DMEA). Examples of commercially available tertiary amine catalysts are those sold under the tradenames Niax, Tegoamin and Dabco (all trademarks). The catalyst is typically used in an amount of from 0.01 to 2.0 parts by weight per hundred parts by weight of polyether polyol (php). Preferred amounts of catalyst are from 0.05 to 1.0 php.

The use of foam stabilisers (surfactants) is well known. Organosilicone surfactants are most conventionally applied as foam stabilisers in polyurethane production. A large variety of such organosilicone surfactants is commercially available. Usually, such foam stabiliser is used in an amount of from 0.01 to 5.0 parts by weight per hundred parts by weight of polyol (pphp). Preferred amounts of stabiliser are from 0.25 to 2.0 pphp, more preferably of from 0.75 to 1.5 pphp.

The use of cross-linking agents in the production of polyurethane foams is also well known. In the present invention, the functionality of such optional cross-linking agent (or crosslinker) is higher than the maximum functionality of chain extender component c). Polyfunctional glycol amines are known to be useful for this purpose. The polyfunctional glycol amine which is most frequently used and is also useful in the preparation of polyurethane foams, especially flexible polyurethane foams, is diethanol amine, often abbreviated as DEOA. If used at all, the cross-linking agent is applied in amounts up to 2 parts by weight per hundred parts by weight of polyol (pphp), but amounts in the range of from 0.01 to 0.5 pphp are most suitably applied. Preferably, in the present invention, no cross-linking agent as described above is used.

In addition, other well-known auxiliaries, such as colorants, flame retardants and fillers, may also be used during the polyurethane preparation process of the present invention.

The process of the invention may involve combining polyisocyanate component a), polyether polyol component b), chain extender component c), the blowing agent, a catalyst and optionally surfactant, crosslinker, flame retardant, colorant and/or filler, in any suitable manner to obtain the polyurethane foam. For example, the present process may comprise mixing polyether polyol component b), chain extender component c), the blowing agent, a catalyst and any other optional component(s) except the polyisocyanate, and then adding polyisocyanate component a).

In the present invention, the polyurethane foam may have a relatively large foam volume, for example at least 5 liters or at least 10 liters or at least 50 liters or at least 100 liters or at least 200 liters or at least 400 liters or at least 600 liters or at least 800 liters or at least 1,000 liters.

Further, the process of the invention may comprise forming the foam into a shaped article before it fully sets. Suitably, forming the foam may comprise pouring the liquid mixture containing all components into a mould before gelling is complete.

The present invention also relates to a polyurethane foam obtainable by the above-described process, and to a shaped article comprising the polyurethane foam obtained by the above-described process or a polyurethane foam obtainable by the above-described process.

The invention is further illustrated by the following Examples.

### EXAMPLES

### 1. Experimental Procedure Materials (polyether polyol, polyisocyanate and other components) used in the polyurethane foam experiments are described in Table 1 below.

TABLE 1

| | |
|---|---|
| | POLYETHER POLYOL |
| Polyol A | Made by ring-opening polymerization of |
| | propylene oxide in the presence of DMC catalyst |
| | and monopropylene glycol: MW = 2,000 g/mol; OH |
| | number = 56 mg KOH/g; functionality = 2.0 |
| | POLYISOCYANATE |
| TDI-80 | 80:20 (by weight) blend of 2,4- and 2,6-isomers |
| | of TDI (tolylene diisocyanate) commercially |
| | available from Mitsui; free NCO content = |
| | 48.3%; functionality = 2.0 |
| | OTHER COMPONENTS |
| BDO | 1,4-butanediol (chain extender); MW = 90.12 |
| | g/mol; functionality = 2.0 |
| T-9 | Stannous octoate catalyst, commercially |
| | available from Air Products and Chemicals |
| Niax A33 | Amine based catalyst available from Momentive |
| | Performance Materials |
| Niax L580 | Silicone based surfactant commercially |
| | available from Momentive Performance Materials |

DMC = double metal cyanide;
MW = molecular weight

In the polyurethane foam experiments, the non-polyisocyanate components were mixed in a high-speed mixer at about 2,500 rpm for 40 seconds (Experiments 1.1-1.4 and 2.1-2.2) or at about 800 rpm for 75 seconds (Experiments 3.1-3.2 and 4.1). Then the polyisocyanate component was added and the mixture was stirred for around 5 seconds and then poured into 10 a box to form a polyurethane foam. The full rise time was measured. The full rise time was the time period between the time of adding the polyisocyanate and the time at which a maximum height was achieved. The foam volume produced in the experiments increased in the following order: Exp. 1.1-1.4 (smallest), Exp. 2.1-2.2, Exp. 3.1-3.2 and Exp. 4.1 (largest). Further, the foam was sliced as per the requirements and the density of the foam was measured according to ASTM D3574 (sample size 100*100*50 mm³, 2 samples/foam). In case of foam split or collapse (as observed visually), the density was not measured.

### 2. Polyurethane Foam Experiments

Experiments 1.1 to 1.4, carried out using 225 grams of the non-polyisocyanate components and a foaming box having dimensions of 30 cm*20 cm*15 cm, are described in Table 2 below.

TABLE 2

| | 1.1 | 1.2 (*) | 1.3 | 1.4 (*) |
|---|---|---|---|---|
| Experiment | | | | |
| Polyol A (pbw) | 99 | 100 | 99 | 100 |
| BDO (pbw) | 1 | 0 | 1 | 0 |
| Polyol A:BDO (weight) | 99:1 | — | 99:1 | — |
| Water (pbw) | 4 | 4 | 4 | 4 |
| T-9 (pbw) | 0.2 | 0.2 | 0.2 | 0.2 |
| Niax A33 (pbw) | 0.4 | 0.4 | 0.4 | 0.4 |
| Niax L580 (pbw) | 1 | 1 | 1 | 1 |
| TDI-80 (isocyanate index) | 105 | 105 | 115 | 115 |
| Properties | | | | |
| Full rise time (s) | 104 | 115 | 99 | 100 |
| Foam collapse or split? | No | Split | No | Split |
| Density (kg/m³) | 22.5 | ND | 21.9 | ND |

(*) = not according to invention;
pbw = parts by weight;
ND = not determined

Experiments 1.1 to 1.4 comprised two sets of experiments, one at an isocyanate index of 105 (Exp. 1.2 and 1.3) and one at an index of 115 (Exp. 1.3 and 1.4). As can be seen from Table 2 above, when adding 1,4-butanediol (BDO) which corresponds with chain extender component c) to be used in accordance with the present invention, as in Exp. 1.1 and 1.3, a foam collapse and a foam split were advantageously prevented at both said isocyanate indices, and low-density polyurethane foams having a density of around 22 kg/m³ were advantageously obtained. On the contrary, in (comparative) Exp. 1.2 and 1.4, wherein no BDO was used, a foam split occurred.

Experiments 2.1 and 2.2, carried out using 1,200 grams of the non-polyisocyanate components and a foaming box having dimensions of 50 cm*50 cm*24 cm, are described in Table 3 below.

TABLE 3

| | 2.1 | 2.2 |
|---|---|---|
| Experiment | | |
| Polyol A (pbw) | 98.5 | 98.5 |
| BDO (pbw) | 1.5 | 1.5 |
| Polyol A:BDO (weight) | 65.7:1 | 65.7:1 |
| Water (pbw) | 4 | 4 |
| T-9 (pbw) | 0.20 | 0.15 |
| Niax A33 (pbw) | 0.4 | 0.4 |
| Niax L580 (pbw) | 1 | 1 |
| TDI-80 (isocyanate index) | 105 | 112 |
| Properties | | |
| Full rise time (s) | 104 | 115 |
| Foam collapse or split? | No | No |
| Density (kg/m³) | 21.6 | 21.3 |

pbw = parts by weight

As can be seen from Table 3 above, also when carrying out the foaming on a larger scale (as compared to Exp. 1.1 to 1.4), when adding 1,4-butanediol (BDO) which corresponds with chain extender component c) to be used in accordance with the present invention, advantageously neither any foam collapse nor any foam split occurred at similar isocyanate indices (see Exp. 2.1 and 2.2, wherein isocyanate indices of 105 and 112, respectively, were applied), and low-density polyurethane foams having a density of around 21-22 kg/m³ were advantageously obtained.

Experiments 3.1 and 3.2, carried out using 7.5 kilograms of the non-polyisocyanate components and a foaming box having dimensions of 1 m*1 m*1 m, are described in Table 4 below.

TABLE 4

| | 3.1 | 3.2 (*) |
|---|---|---|
| Experiment | | |
| Polyol A (pbw) | 98 | 100 |
| BDO (pbw) | 2 | 0 |
| Polyol A:BDO (weight) | 49:1 | — |
| Water (pbw) | 4.0 | 4.0 |
| T-9 (pbw) | 0.20 | 0.20 |
| Niax A33 (pbw) | 0.40 | 0.40 |
| Niax L580 (pbw) | 1.00 | 1.00 |
| TDI-80 (isocyanate index) | 110 | 110 |
| Properties | | |
| Full rise time (s) | 108 | 111 |
| Foam collapse or split? | No | Split |
| Density (kg/m³) | 21.1 | ND |

(*) = not according to invention;
pbw = parts by weight;
ND = not determined

As can be seen from Table 4 above, also when carrying out the foaming on a larger scale (as compared to Exp. 1.1 to 1.4), when adding 1,4-butanediol (BDO) which corresponds with chain extender component c) to be used in accordance with the present invention, as in Exp. 3.1, a foam collapse and a foam split were advantageously prevented, and a low-density polyurethane foam having a density of 21.1 kg/m³ was advantageously obtained. On the contrary, in (comparative) Exp. 3.2, wherein no BDO was used, a full foam split occurred.

Experiment 4.1, carried out using 11.5 kilograms of the non-polyisocyanate components and a foaming box having dimensions of 1 m*1 m*1 m, is described in Table 5 below.

TABLE 5

| | 4.1 |
|---|---|
| Experiment | |
| Polyol A (pbw) | 98 |
| BDO (pbw) | 2 |
| Polyol A:BDO (weight) | 49:1 |
| Water (pbw) | 4.0 |
| T-9 (pbw) | 0.20 |
| Niax A33 (pbw) | 0.40 |
| Niax L580 (pbw) | 1.00 |
| TDI-80 (isocyanate index) | 110 |
| Properties | |
| Full rise time (s) | 105 |
| Foam collapse or split? | No |
| Density (kg/m³) | 21.3 |

pbw = parts by weight

As can be seen from Table 5 above, also when carrying out the foaming on a larger scale (as compared to Exp. 1.1 to 1.4), when adding 1,4-butanediol (BDO) which corresponds with chain extender component c) to be used in accordance with the present invention, advantageously neither any foam collapse nor any foam split occurred at a similar isocyanate index (see Exp. 4.1, wherein an isocyanate index of 110 was applied), and a low-density polyurethane foam having a density of 21.3 kg/m³ was advantageously obtained.

1. A process for preparing a polyurethane foam having a density lower than 30 kg/m³ which process comprises reacting, in the presence of a blowing agent:
a) a polyisocyanate component;
b) a polyether polyol component having a molecular weight of at least 1,000 g/mol and a functionality which is higher than 1.5 and lower than 2.5; and
c) a chain extender component having a molecular weight of at most 500 g/mol and a functionality which is higher than 1.5 and lower than 2.5.

2. The process according to claim 1, wherein polyether polyol component b) has a functionality of from 1.7 to 2.2.

3. The process according to claim 1, wherein chain extender component c) has a functionality of from 1.7 to 2.2.

4. The process according to claim 1, wherein the isocyanate index is higher than 95.

5. The process according to claim 1, wherein the density of the polyurethane foam is of from 10 to 28 kg/m³.

6. The process according to claim 1, wherein the molecular weight of polyether polyol component b) is of from 1,000 to 5,000 g/mol.

7. The process according to claim 1, wherein the molecular weight of chain extender component c) is of from 50 to 500 g/mol.

8. The process according to claim 1, wherein chain extender component c) comprises an alkanediol having 2 to 10 carbon atoms.

9. A polyurethane foam obtainable by the process according to claim 1.

10. A shaped article comprising a polyurethane foam obtained by the process according to claim 1.
